(19) United States
(12) Patent Application Publication
(10) Pub. No.: US 2017/0147986 A1
(43) Pub. Date: May 25, 2017

(54) METHOD AND DEVICE FOR COUNTING EVENTS IN CALENDAR

(71) Applicants: Le Holdings (Beijing) Co., Ltd., Beijing (CN); LETV SPORTS CULTURE DEVELOP(BEIJING) CO.,LTD., Beijing (CN)

(72) Inventors: Dongchen HUO, Beijing (CN); Ranyang WANG, Beijing (CN); Zhenhua YAN, Beijing (CN)

(21) Appl. No.: 15/245,214

(22) Filed: Aug. 24, 2016

Related U.S. Application Data
(63) Continuation of application No. PCT/CN2016/082623, filed on May 19, 2016.

(30) Foreign Application Priority Data
Nov. 19, 2015 (CN) 201510802470.4

(51) Int. Cl. G06Q 10/10

(52) U.S. Cl. CPC G06Q 10/1095

(57) ABSTRACT

Disclosed are a method and a device for counting events in a calendar. The method includes: obtaining a subject calendar by acquiring a subject of a calendar and time of a subject event; sending a request for acquiring a subject event to a server, the request for acquiring a subject event carrying a subject of the subject calendar and time of a subject event; receiving subject event information returned by the server, the subject event information being acquired by the server according to the subject of the subject calendar and the time of the subject event; and adding the subject event information into corresponding time of the subject calendar.

### CROSS-REFERENCE TO RELATED APPLICATIONS

This application is a continuation of International application Ser. No. PCT/CN2016/082623, filed on May 19, 2016, which is based upon and claims priority to Chinese Patent Application No. 201510802470.4, filed on Nov. 19, 2015, the entire contents of which are incorporated herein by reference.

### TECHNICAL FIELD

The present disclosure relates to internet technologies, and more particularly, to a method and a device for counting events in a calendar.

### BACKGROUND

On existing electronic products such as a computer or a mobile phone, a user may use an electronic calendar to view a date. The calendar generally counts national legal holidays or traditional solar terms and labels them on corresponding dates in the calendar so that the user may see information related to holidays and festivals or solar terms whenever the user views the calendar.

However, in the process of actually using a calendar by the user, in addition to knowing about information on holidays and festivals or solar terms, the user often needs to count important events at certain dates through the calendar, where these important events are mainly targeted at the user personally. Therefore, different users' calendars are different. To meet the user's above requirements, an existing calendar provides an editing function so that the user can edit events for dates in the calendar to let the user conveniently and clearly know about corresponding important events at specific dates. However, user manual editing is required for this manner, when important events are edited for multiple dates, and a data volume of edition is very large for the user, which brings great inconvenience for the user. Therefore, how to customize events counted in a calendar becomes a problem to be solved urgently when an existing calendar is used.

### SUMMARY

The present disclosure provides a method and a device for counting events in a calendar, which are designed to solve a defect that in the prior art using a calendar to count events can only rely on a user's manual editing, thereby achieving an objective of customizing events counted in a calendar.

In a first aspect, embodiments of the present disclosure provide a method for counting events in a calendar, implemented by a client, including:

obtaining a subject calendar by acquiring a subject of a calendar and time of a subject event;

sending a request for acquiring a subject event to a server, the request for acquiring a subject event carrying a subject of the subject calendar and time of a subject event;

receiving subject event information returned by the server, the subject event information being acquired by the server according to the subject of the subject calendar and the time of the subject event; and

adding the subject event information into corresponding time of the subject calendar.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for counting events in a calendar mentioned by embodiments of the present disclosure.

In a third aspect, embodiments of the present disclosure provide a non-transitory computer-readable storage medium storing executable instructions thereon, which, when executed by an electronic device with a touch-sensitive display, cause the electronic device to perform any methods for counting events in a calendar mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for counting events in a calendar in accordance with some embodiments;

FIG. 2 is a block diagram showing constitution of a device for counting events in a calendar in accordance with some embodiments;

FIG. 3 is a schematic diagram of an entity structure of a server in accordance with some embodiments; and

FIG. 4 is a block diagram of an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

In an existing electronic calendar, except information on routine holidays and festivals or solar terms is provided, often a calendar editing function is provided for a user so that the user can edit an event for a date in the calendar. However, user manual editing is required for this manner, when events are needed to be edited for multiple dates, and a data volume of edition is very large, which brings great inconvenience for the user's operation.

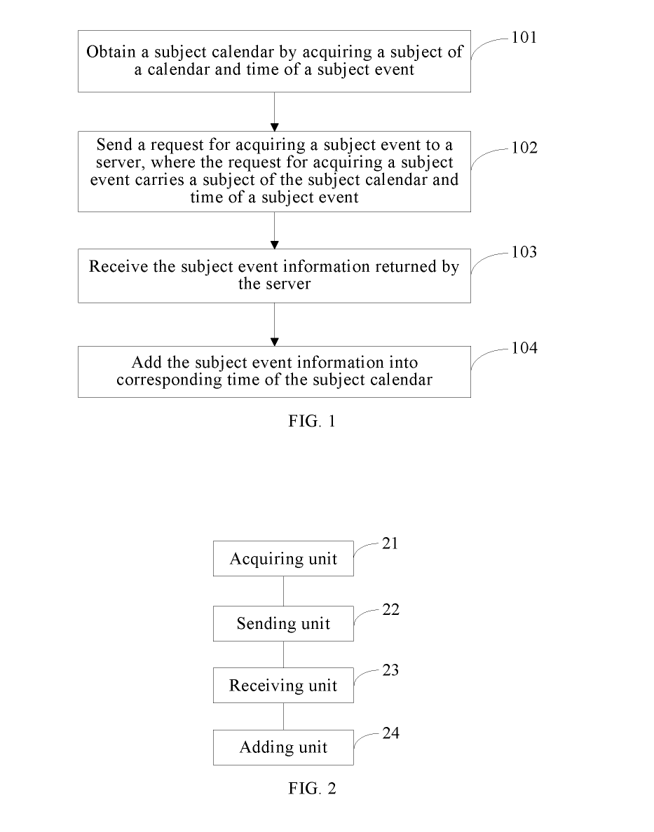

To solve the defect that in the prior art using a calendar to count events can only rely on a user's manual editing, embodiments of the present disclosure provide a method for counting events in a calendar, implemented by a client, as shown in FIG. 1, the method includes:

101: The client obtains a subject calendar by acquiring a subject of a calendar and time of a subject event.

In an existing calendar, holidays and festivals information or solar terms information may be counted for dates corresponding to the holidays and festivals or dates corresponding to the solar terms so that a user can conveniently know about dates and event information corresponding to the dates when the user uses the calendar. Further, a calendar for editing an event by a user appears, namely, a calendar editing function is provided for a user so that the user can customize edition of event information for a date in the calendar. However, user manual operation is required for this manner. To simplify this editing process, embodiments of the present disclosure provide a method for counting events in a calendar. Step 101 needs to be executed to obtain a subject calendar by acquiring a subject of a calendar and time of a subject event. Compared with a calendar having an ordinary event-recording function in the prior art, in the subject calendar, the user can customize setting of a subject of a calendar and time of a subject event at the client; or the user selects the subject of the calendar and time of the subject event from subject information and subject event time information provided by the client. The client can obtain the subject calendar only by acquiring the calendar subject and time of the subject event of user-defined setting or by acquiring a user-selected calendar subject and time of the subject event. The calendar subject is a type of to-be-counted events in the calendar, for example, to-be-counted entertainment events and sporting events, etc. The objective of Step 101 is that the client acquires a type of to-be-counted events and events of the type which are needed to be counted within which period of time.

102: The client sends a request for acquiring a subject event to a server, where the request for acquiring a subject event carries a subject of the subject calendar and time of a subject event.

After the calendar subject and the time of the subject event are acquired in Step 101, embodiments of the present disclosure need to execute Step 102: sending the request for acquiring a subject event to the client, where the request for acquiring a subject event carries a subject of the subject calendar and time of the subject event so that the server collects subject event information within corresponding time according to the subject carried in the request and the time of the subject event and returns the subject event information to the client after receiving the request for acquiring a subject event.

103: The client receives the subject event information returned by the server.

After the request for acquiring a subject event is sent to the client in Step 102, the client receives subject event information returned by the server, where the subject event information is acquired by the server according to the subject of the subject calendar and the time of the subject event.

104: The client adds the subject event information into corresponding time of the subject calendar.

After the subject event information returned by the server is received in Step 103, in embodiments of the present disclosure, it is needed to respectively add subject event information into corresponding time of the subject calendar according to time of the subject event information. For example, in a calendar generally *day*month*year is taken as a unit of time. Therefore, in embodiments of the present disclosure, subject event information within several days (namely, time of the subject event) since a certain date is correspondingly added into a corresponding date of the subject calendar.

By using the method for counting events in a calendar provided by embodiments of the present disclosure, a subject calendar can be obtained by acquiring by a client a subject of the calendar and time of a subject event set up by a user; a request for acquiring a subject event is sent to a server, where the request carries a subject and time of the subject event; the server acquires subject event information according to the subject in the request and the time of the subject event and returns the subject event information to the client, and the client correspondingly adds the subject event information into the calendar according to a time relationship. Compared with a manner in the prior art in which relevant event information needs to be added on a corresponding data in the calendar manually, the method and the device for counting events in a calendar provided by embodiments of the present disclosure can achieve the objective of customizing events counted in the calendar through collaboration between the client and the server, thereby solving the defect of complex and cumbersome operation caused by manually editing event information in the calendar by the user.

To better understand the method as shown in FIG. 1, the method for counting events in a calendar provided by embodiments of the present disclosure is described in detail by taking sports events as the subject of the calendar and taking counting sports events in the calendar as an example.

Embodiments of the present disclosure provide a method for counting events in a calendar, in the method, a user does not need to edit an event manually but needs to set up a subject of the calendar and time of a subject event. In the process of setting, the user can customize setting of the subject of the calendar and the time of the subject event, or the user can select the subject of the calendar and the time of the subject event according to a subject option and a time option provided by the client. As an alternative embodiment, in embodiments of the present disclosure, the client can obtain the subject calendar by acquiring the subject selected by the user from a subject option of the calendar and by acquiring the time of the subject event selected by the user from a time option of the calendar. The subject option includes multiple pieces of subject information such as subjects of movie and TV play, subjects of sports events and subjects of entertainment programs or the like. The time option includes a statistical starting date and a statistical ending date. After the statistical starting date and the statistical ending date are selected from the time option, this represents that the user needs to acquire a subject event between the statistical starting date and the statistical ending date. After the user sets up the subject option and the time option of the calendar through the above-mentioned way, the client finally can acquire subject event information corresponding to the subject between the statistical starting date and the statistical ending date according to user-set information.

In the embodiments of the present disclosure, after the subjects of sports events are acquired from the subject option of the calendar, and the statistical starting date and the statistical ending date of the subjects of sports events are acquired from the time option of the calendar, to obtain all sports events between the statistical starting date and the statistical ending date, the client needs to send a request for acquiring a subject event to the server, where the request for acquiring a subject event carries the subjects of sports events as well as the statistical starting date and the statistical ending date so that after receiving the request for acquiring a subject event, the server can collect sports events information within a corresponding date according to the subjects of sports events as well as the statistical starting date and the statistical ending date carried in the request. The sports events information collected by the server includes but is not limited to: football sports events, volleyball sports event, tennis sports event, basketball sports event, ping-pong sports events, track and field sports events and boxing sports events or the like. All sports events related to physical education belong to the sports events information in the embodiments of the present disclosure. In actual situation, a JavaScript program of the client can send an ajax asynchronous request for acquiring a subject event to the server to acquire subject event information between the statistical starting date and the statistical ending date. It should be explained that the JavaScript program of the client also can send an ajax synchronous request for acquiring a subject event to the server to acquire the subject event information. The subject event information can be acquired no matter by sending the ajax synchronous request or by sending the ajax asynchronous request. However, since the JavaScript program is single-threaded, executing the ajax request may consume certain time, or even no result is returned due to network failure. When a synchronous request is executed, subsequent codes cannot be executed until the ajax result is returned. Whereas it is unnecessary to wait the ajax result to be returned to execute subsequent codes when an asynchronous request is executed. Therefore, to acquire the subject event information without affecting the user's other operations, in the embodiments of the present disclosure, by default an ajax asynchronous request for acquiring a subject event is sent to the server to acquire the subject event information.

After receiving the request for acquiring a subject event, sent by the client, carrying information on the subjects of sports events as well as the statistical starting date and the statistical ending date, the server can read the information on the subjects of sports events as well as the statistical starting date and the statistical ending date carried in the request, acquire sports events information of every day between the statistical starting date and the statistical ending date according to the information, and return summarized sports events information of every day to the client. It should be explained that the sports events information of every day includes: which sports events being provided within which period of time every day and how many sports events being provided every day, etc. For example, the acquired sports events information can be AFC Champions League finals from 15:00 to 17:00, 12, December, or can be three AFC Champions League group matches on 10, December, or can simply be five sports events on 5, December. Sports events information acquired by the server needs to be determined according to subjects set up by the user at the client. If the subjects set up by the user at the client are sports events, the server acquires all sports events within statistical time, including: football sports events, basketball sports events, track and field sports event and so on. If the subjects set up by the user at the client are subdivided into football sports events, the server acquires all football sports events within statistical time. Calendar subjects are not limited in the embodiments of the present disclosure, which can include subjects of sports events on a large scale or subjects of football sports events on a small scale.

By taking an example in which quantity of subject events is regarded as subject event information, if the calendar subjects are set by the user at the client as subjects of sports events on a large scale, and the statistical starting date and the statistical ending date are respectively set as 1, October and 3, October, after the client sends a request for acquiring a subject event carrying the information to the server, the server can collect, according to the information carried in the request for acquiring a subject event, that there are three sports events (a football sports event, a basketball sports event and a volleyball sports event) on 1, October, there is no sports event on 2, October, and there are two sports events (a boxing sports event and a football sports event) on 3, October. After collecting quantity of all sports events within the statistical time, the server can summarize quantity of sports events of every day and return it to the client. After receiving the quantity of sports events returned by the server, the client refreshes the subject calendar, and adds quantity of sports events of every day within the statistical time onto a corresponding date of the subject calendar.

By taking an example in which quantity of subject events is regarded as the subject event information, if the calendar subjects are set by the user at the client as subjects of football sports events on a small scale, and the statistical starting date and the statistical ending date are respectively set as 1, October and 3, October, after the client sends a request for acquiring a subject event carrying the information to the server, the server can collect, according to the information carried in the request for acquiring a subject event, that there is one football sports event on 1, October, there is no sports event on 2, October, and there is one football sports event on 3, October. After acquiring quantity of all football sports events within the statistical time, the server can summarize quantity of football sports events of every day and return it to the client. After receiving the quantity of football sports events returned by the server, the client refreshes the subject calendar, and adds quantity of football sports events of every day within the statistical time onto a corresponding date of the subject calendar.

By taking an example in which period of time of occurrence of subject events within a corresponding date is regarded as the subject event information, if the calendar subjects are set by the user at the client as subjects of football sports events on a small scale, and the statistical starting date and the statistical ending date are respectively set as 1, October and 3, October, after the client sends a request for acquiring a subject event carrying the information to the server, the server can collect, according to the information carried in the request for acquiring a subject event, that there is one football sports event from 15:00 to 17:00 on 1, October, there is no sports event on 2, October, and there is one football sports from 20:00 to 22:00 on 3, October. After acquiring information on all football sports events within the statistical time, the server can summarize football sports events information of every day and return it to the client. After receiving the football sports events information returned by the server, the client refreshes the subject calendar, and correspondingly adds football sports events information of a corresponding period of time of every day within the statistical time onto a corresponding date of the subject calendar.

Reference is made above merely by taking quantity of subject events counted in a calendar and occurrence time of subject events as an example, of course other information of the subject events can be counted, for example, it can be counted in the calendar what kind of matches a certain athlete takes part in at a certain day. Subject event information counted in a calendar is not limited in form in embodiments of the present disclosure, which can be subject event quantity information or information of period of time at which the subject events occur every day, or other information of the subject events. Any event counted by using the method for counting events in a calendar provided by embodiments of the present disclosure shall fall within the scope of protection of the embodiments of the present disclosure.

As an application of the method as shown in FIG. 1, embodiments of the present disclosure further provide a device for counting events in a calendar, as shown in FIG. 2, the device includes: an acquiring unit 21, a sending unit 22, a receiving unit 23 and an adding unit 24, where

the acquiring unit 21 is configured to obtain a subject calendar by acquiring a subject of the calendar and time of a subject event;

the sending unit 22 is configured to send a request for acquiring a subject event to a server, the request for acquiring a subject event carries a subject of the subject calendar and time of a subject event;

the receiving unit 23 is configured to receive subject event information returned by the server, the subject event information is acquired by the server according to the subject of the subject calendar and the time of the subject event; and

the adding unit 24 is configured to add the subject event information into corresponding time of the subject calendar.

Further, the acquiring unit 21 is configured to obtain the subject calendar by acquiring the subject from a subject option of the calendar and acquiring the time of the subject event from a time option of the calendar, and the time option includes a statistical starting date and a statistical ending date. In actual situation, the acquiring unit 21 of the client is further configured to draw a subject calendar table through a JavaScript program.

Further, the sending unit 22 is configured to send an asynchronous request for acquiring a subject event to the server to acquire subject event information between the statistical starting date and the statistical ending date. In actual situation, the sending unit 22 of the client can send an ajax asynchronous request for acquiring a subject event to the server through the JavaScript program to acquire subject event information between the statistical starting date and the statistical ending date.

Further, the receiving unit 23 is configured to receive subject event information returned by the server of each day between the statistical starting date and the statistical ending date, where the subject event information at least includes quantity of subject events. In actual situation, in addition to receiving subject event quantity information, the receiving unit 23 also can receive other information of the subject event, for example, subject event information corresponding to a specific period of time within each day or figure or executive body information and so on involved with the subject event.

Further, the adding unit 24 is configured to correspondingly add quantity of subject events of each day between the statistical starting date and the statistical ending date onto a corresponding date of the subject calendar. Alternatively, the adding unit 24 is configured to add, according to the subject event information actually received by the receiving unit 23, subject event information corresponding to a specific period of time within each day or figure or executive body information and so on involved with the subject event onto a corresponding date of the subject calendar.

By using the device for counting events in a calendar provided by embodiments of the present disclosure, a subject calendar can be obtained by acquiring by a client a subject of the calendar and time of a subject event set up by a user; a request for acquiring a subject event is sent to a server, where the request carries a subject of the subject calendar and time of the subject event; the server acquires subject event information according to the subject in the request and the time of the subject event and returns the subject event information to the client, and the client correspondingly adds the subject event information into the calendar according to a time relationship. Compared with a manner in the prior art in which relevant event information needs to be added on a corresponding data in the calendar manually, the method and the device for counting events in a calendar provided by embodiments of the present disclosure can achieve the objective of customizing events counted in the calendar through collaboration between the client and the server, thereby solving the defect of complex and cumbersome operation caused by manually editing event information in the calendar by the user.

Furthermore, the device for counting events in a calendar provided by embodiments of the present disclosure can set subjects in the subject option of a calendar on a large scale or set subjects on a small scale, and add quantity of events under a corresponding subject into a corresponding date of the calendar so that the user can acquire quantity of corresponding subject events at a date when the user views a calendar. By this means the user can achieve an effect of counting events of different subjects in the calendar without manually editing event information.

In allusion to the foregoing device for counting events in a calendar, It should be explained that functions of each unit module used in the embodiments of the present disclosure may be implemented through a hardware processor.

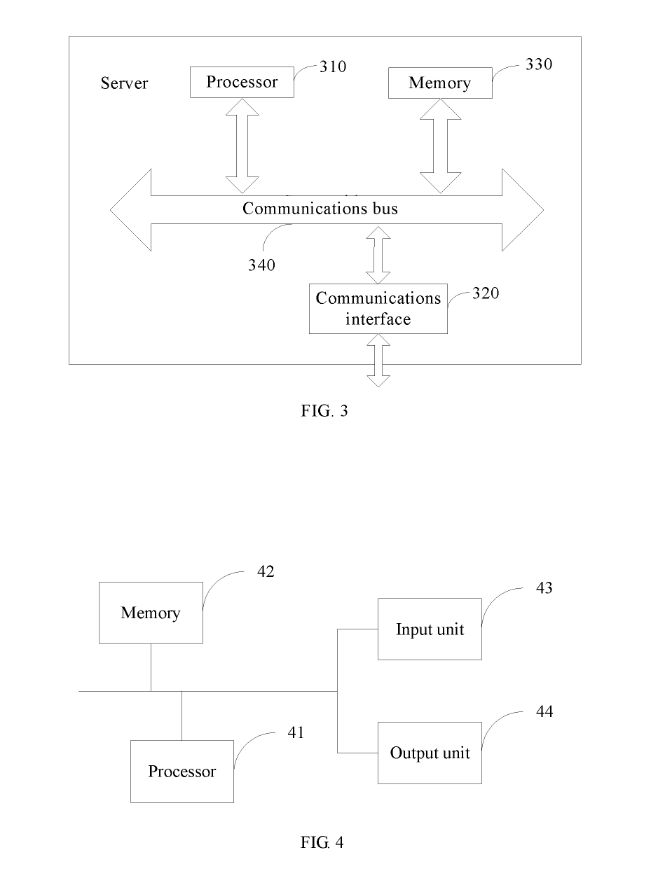

FIG. 3 shows a schematic diagram of an entity structure of a server, as shown in FIG. 3, the server can include: a processor 310, a communications interface 320, a memory 330 and a communications bus 340, where the processor 310, the communications interface 320 and the memory 330 complete communications among each other through the communications bus 340. The communications interface 320 can be configured to implement information transmission between the server and the client. The processor 310 can invoke a logic instruction in the memory 330 to execute the following method: obtaining a subject calendar by acquiring a subject of a calendar and time of a subject event; sending a request for acquiring a subject event to a server, where the request for acquiring a subject event carries a subject of the subject calendar and time of a subject event; receiving subject event information returned by the server, where the subject event information is acquired by the server according to the subject of the subject calendar and the time of the subject event; and adding the subject event information into corresponding time of the subject calendar.

In addition, when a logic instruction in the foregoing memory 330 can be implemented in the form of a software functional unit and is sold or used as an independent product, the logic instruction can be stored in a computer-readable storage medium. Based on such an understanding, the technical solution of the present disclosure in essence or that part of contribution to the prior art or a part of the technical solution may be embodied in the form of software products, which may be stored in a storage medium, comprising some instructions to cause a computer device (a personal computer, a server or a network device and so on) to execute all or a part of steps of the method as recited in the embodiments of the present disclosure. The aforementioned storage medium includes: a USB flash disk, a mobile hard disk, a read-only memory (ROM), a random access memory (RAM), a magnetic disk or an optical disk and other media capable of storing a program code.

Further, an embodiment of the present disclosure further provides a non-transitory computer-readable storage medium storing executable instructions, which can be executed by an electronic device to perform any methods for counting events in a calendar mentioned by embodiments of the present disclosure.

FIG. 4 is a block diagram of an electronic device which is configured to perform the methods for counting events in a calendar according to an embodiment of the present disclosure. As shown in FIG. 4, the device includes: one or more processors 41 and memory 42. A processor 41 is showed in FIG. 4 for an example.

Device which is configured to perform the methods for counting events in a calendar can also include: input unit 43 and output unit 44.

Processor 41, memory 42, input unit 43 and output unit 44 can be connected by BUS or other methods, and BUS connecting is showed in FIG. 4 for an example.

Memory 42 can be used for storing non-transitory software program, non-transitory computer executable program and modules as a non-transitory computer-readable storage medium, such as corresponding program instructions/modules for the methods for counting events in a calendar mentioned by embodiments of the present disclosure (such as shown in FIG. 2, acquiring unit 21, sending unit 22, receiving unit 23 and adding unit 24). Processor 41 performs kinds of functions and counting events in a calendar of the electronic device by executing non-transitory software program, instructions and modules which are stored in memory 42, thereby realizes the methods for counting events in a calendar mentioned by embodiments of the present disclosure.

Memory 42 can include program storage area and data storage area, thereby the operating system and applications required by at least one function can be stored in program storage area and data created by using the device for counting events in a calendar can be stored in data storage area. Furthermore, memory 42 can include high speed Random-access memory (RAM) or non-volatile memory such as magnetic disk storage device, flash memory device or other non-volatile solid state storage devices. In some embodiments, memory 42 can include long-distance setup memories relative to processor 41, which can communicate with the device for counting events in a calendar by networks. The examples of said networks are including but not limited to Internet, Intranet, LAN, mobile Internet and their combinations.

Input unit 43 can be used to receive inputted number, character information and key signals causing user configures and function controls of the device for counting events in a calendar. Output unit 44 can include a display screen or a display device.

The said module or modules are stored in memory 42 and perform the methods for counting events in a calendar when executed by one or more processors 41.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The device embodiments set forth above is merely exemplary, where units described as detached parts can be or not be detachable physically; parts displayed as units can be or not be physical units, i.e., either located at the same place, or distributed on a plurality of network units. Modules may be selected in part or in whole according to actual needs for achieving objectives of the solution of this embodiment.

It can be known from the foregoing implementation modes, those skilled in the art may clearly know that various implementation modes can be implemented by feat of software and necessary general hardware platform, or of course by means of hardware. Based on such an understanding, the foregoing technical solutions in essence or that part of contribution to the prior art may be embodied in the form of software products, which may be stored in computer-readable storage media, such as ROM/RAM, diskettes or optical disks and the like, including some instructions so that it is possible to execute embodiments or methods as recited in some parts of embodiments by a computer equipment (a personal computer, or a server, or network equipment, etc.).

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the spirit or scope of the technical solutions of the embodiments of the present disclosure.

What is claimed is:

1. A method for counting events in a calendar, implemented by a client, comprising:
obtaining a subject calendar by acquiring a subject of a calendar and time of a subject event;
sending a request for acquiring a subject event to a server, the request for acquiring a subject event carrying a subject of the subject calendar and time of a subject event;
receiving subject event information returned by the server, the subject event information being acquired by the server according to the subject of the subject calendar and the time of the subject event; and
adding the subject event information into corresponding time of the subject calendar.

2. The method according to claim 1, wherein acquiring a subject of the calendar and time of a subject event to obtain a subject calendar comprises:
obtaining the subject calendar by acquiring the subject from a subject option of the calendar and by acquiring the time of the subject event from a time option of the calendar, the time option comprising a statistical starting date and a statistical ending date.

3. The method according to claim 2, wherein sending a request for acquiring a subject event to a server, the request for acquiring a subject event carrying a subject of the subject calendar and time of a subject event comprises:
sending an asynchronous request for acquiring a subject event to the server to acquire subject event information between the statistical starting date and the statistical ending date.

4. The method according to claim 3, wherein receiving subject event information returned by the server comprises:
receiving subject event information returned by the server of each day between the statistical starting date and the statistical ending date, the subject event information at least comprises quantity of the subject events.

5. The method according to claim 4, wherein adding the subject event information into corresponding time of the subject calendar comprises:
correspondingly adding quantity of subject events of each day between the statistical starting date and the statistical ending date onto a corresponding date of the subject calendar.

6. An electronic device, comprising:
at least one processor; and
a memory communicably connected with the at least one processor for storing instructions executable by the at least one processor, wherein execution of the instructions by the at least one processor causes the at least one processor to:
obtain a subject calendar by acquiring a subject of a calendar and time of a subject event;
send a request for acquiring a subject event to a server, the request for acquiring a subject event carrying a subject of the subject calendar and time of a subject event;
receive subject event information returned by the server, the subject event information being acquired by the server according to the subject of the subject calendar and the time of the subject event; and
add the subject event information into corresponding time of the subject calendar.

7. The electronic device according to claim 6, wherein acquiring a subject of the calendar and time of a subject event to obtain a subject calendar comprises:
obtaining the subject calendar by acquiring the subject from a subject option of the calendar and by acquiring the time of the subject event from a time option of the calendar, the time option comprising a statistical starting date and a statistical ending date.

8. The electronic device according to claim 7, wherein sending a request for acquiring a subject event to a server, the request for acquiring a subject event carrying a subject of the subject calendar and time of a subject event comprises:
sending an asynchronous request for acquiring a subject event to the server to acquire subject event information between the statistical starting date and the statistical ending date.

9. The electronic device according to claim 8, wherein the receiving subject event information returned by the server comprises:
receiving subject event information returned by the server of each day between the statistical starting date and the statistical ending date, the subject event information at least comprises quantity of the subject events.

10. The electronic device according to claim 9, wherein adding the subject event information into corresponding time of the subject calendar comprises:
correspondingly adding quantity of subject events of each day between the statistical starting date and the statistical ending date onto a corresponding date of the subject calendar.

11. A non-transitory computer-readable storage medium storing executable instructions thereon, which, when executed by an electronic device with a touch-sensitive display, cause the electronic device to:
obtain a subject calendar by acquiring a subject of a calendar and time of a subject event;
send a request for acquiring a subject event to a server, the request for acquiring a subject event carrying a subject of the subject calendar and time of a subject event;
receive subject event information returned by the server, the subject event information being acquired by the server according to the subject of the subject calendar and the time of the subject event; and
add the subject event information into corresponding time of the subject calendar.

12. The non-transitory computer-readable storage medium according to claim 11, wherein acquiring a subject of the calendar and time of a subject event to obtain a subject calendar comprises:
obtaining the subject calendar by acquiring the subject from a subject option of the calendar and by acquiring the time of the subject event from a time option of the calendar, the time option comprising a statistical starting date and a statistical ending date.

13. The non-transitory computer-readable storage medium according to claim 12, wherein sending a request for acquiring a subject event to a server, the request for acquiring a subject event carrying a subject of the subject calendar and time of a subject event comprises:
sending an asynchronous request for acquiring a subject event to the server to acquire subject event information between the statistical starting date and the statistical ending date.

14. The non-transitory computer-readable storage medium according to claim 13, wherein the receiving subject event information returned by the server comprises:
receiving subject event information returned by the server of each day between the statistical starting date and the statistical ending date, the subject event information at least comprises quantity of the subject events.

15. The non-transitory computer-readable storage medium according to claim 14, wherein adding the subject event information into corresponding time of the subject calendar comprises:
correspondingly adding quantity of subject events of each day between the statistical starting date and the statistical ending date onto a corresponding date of the subject calendar.
